(19) United States
(12) Patent Application Publication
(10) Pub. No.: US 2004/0252816 A1
(43) Pub. Date: Dec. 16, 2004

(54) Mobile phone sample survey method

(76) Inventor: Christophe Nicolas, Cheseaux-sur-Lausanne (CH)

Correspondence Address: Supervisor, Patent Prosecution Services, PIPER RUDNICK LLP, 1200 Nineteenth Street, N.W., Washington, DC, 20036-2412, US

(21) Appl. No.: 10/460,374

(22) Filed: Jun. 13, 2003

(51) Int. Cl. H04M 11/00

(52) U.S. Cl. 379/92.01

(57) ABSTRACT

The aim of this invention is to increase the efficiency, precision and rapidity of a sample survey so that it becomes an accessible instrument and easy to use by a large number of institutions. Furthermore, the sample survey method must guarantee a random choice of individuals to be polled according to predefined criteria always maintaining said individuals' anonymity.

This aim is reached by an opinion poll method of subscribers to an operator's (OP) mobile telephone network carried out by an institute (IS), characterized by the following steps:

select a group of telephone numbers provided by the mobile telephone network operator (OP) relating to subscribers complying with predefined criteria,

choose randomly a number of fixed numbers among those selected previously,

transmit numerically a sample survey request (RQA) to previously selected numbers followed by sample survey data,

receive and memorize, in the mobile telephone (MO) complying with the selected number, the sample survey data,

determine the ideal moment to present the sample survey to the mobile telephone user,

authenticate the user,

receive the answers to the sample survey questions (REP),

transmit, store and record the answers (REP) according to the predefined criteria.

This invention concerns a sample survey method that uses the mobile telephone network.

A sample survey is a statistical inquiry procedure relating to certain characteristics of a population, starting from observations on a limited but representative sample of the population. The aim of the sample survey is to discover the distribution of opinions of a population on a question or given subject. The results of a sample survey allow a valid conclusion to be the extrapolated for a widespread group of people on the scale of a town, region or country.

All the sample surveys require the anonymity of the individuals included in the sample chosen, that is to say, that no personal details are registered, thus allowing the opinions of the individuals participating in the sample survey to be associated. Furthermore, those taking part in the survey must not be influenced by other participants having already answered, and the results, including partial results, must not be published before the completion of the sample survey.

A known method consists of selecting participants, for example, from a telephone directory, according to a certain number of predetermined criteria such as place of residence and profession. A given number of people, representing the size of the sample, are randomly selected and are then called in turn to answer questions from the sample survey, for example, by telephone. Only the answers related to the predetermined criteria are registered and then recorded.

The precision of the sample survey results, in proportion to the size of the sample, also depends on the quality of the answers given by survey participants, on the availability of these participants and on their representativeness as well as on their motivation. To reflect the entire population, it is necessary that sampling is carried out on all categories of individuals.

Therefore, if it is easy to find a young, employed male citizen, at times it will be more difficult to poll an independent individual over the age of 60 living in the countryside.

A sample survey is only representative if the selected individuals answer questions effectively, thus it is necessary to avoid cases of fraud where a third person or the pollster answers in their place.

The aim of this invention is to increase the efficiency, precision and rapidity of a sample survey so that it becomes an accessible instrument and can be easily used by a large number of institutions. Furthermore, the sample survey method must guarantee a random choice of participants according to predefined criteria, always maintaining the anonymity of these individuals.

This aim is reached by an opinion sample survey method carried out through a mobile telephone network, the sample survey being directed by a sample survey institute and the mobile network being directed by at least one mobile telephone network operator, characterized by the following steps:

select a group of telephone numbers provided by the mobile telephone network operator in relation to subscribers complying with predefined criteria,

choose randomly all or part of the numbers among those previously selected,

transmit numerically the sample survey data to previously selected numbers,

receive and memorize the sample survey data through the mobile telephone that corresponds to the selected number,

determine the ideal moment to present the sample survey to the mobile telephone user,

authenticate the user,

receive the answers to the sample survey questions,

transmit, store and record the answers according to the predefined criteria.

At present, in developed countries, the vast majority of the population has a mobile telephone that offers everyone the possibility of being contacted at any time and in any place. As the sample survey becomes a more and more widely used statistical instrument in a wide variety of areas, particularly in marketing or politics, it is necessary to be able to contact a large number of people easily. Furthermore, the survey participants must answer questions rapidly, for example by choosing an answer among possible answers. The reduction and processing of the results collected will be provided in this way, above all when the number of contacted people becomes relevant.

The sample survey has to be accessible to the largest possible number of mobile telephones regardless of their functional characteristics, thus it is desirable to have a particular application called “interactive” in the form of integrated SIM card software or loaded in the telephone memory. This software can present data to the user and collect answers without needing an on-line connection with a service supplier (such as WAP for example). This software can be used for other applications such as games, lotteries etc.

This software can be installed either automatically during the manufacture of the apparatus, or when the telephone is activated and connected to the network in a suitable memory, or by the sending of a short SMS message asking the user if he/she wishes to take part in a sample survey requiring a special programme to be downloaded beforehand.

This programme allows the readout of the sample survey questions to which an answer can be selected (yes/no/do not know) or a grade in the form of a digit between 1 and 5 for example can be introduced. These answers are then sent to the sample survey institute where they are stored and recorded.

Once the programme is loaded into the telephone, the sample survey data occupies a reduced volume of memory. Therefore, it is easy to store this data in the telephone and determine the ideal moment to carry out this sample survey. In fact, the user could be at wheel of his/her car and thus be unable to answer the telephone. When the user picks up the telephone to make a call, he/she is warned by the readout of a particular symbol, for example that a sample survey is stored and that the user is requested to respond as soon as possible. This possibility of giving a deferred and offline answer is one of the great advantages of the present method over the usual telephone system.

In order to encourage the selected individuals to participate in the sample survey, the requests are made with a special offer consisting for example of a free subscription period, services tariff reductions, extra points etc. These offers are made by the operator that receives the data relating to the individuals having taken part in the survey carried out by the sample survey institute in the form of a list of telephone numbers for example.

The invention will be better understood thanks to the following detailed description that refers to the attached FIGURE serving as a non-limitative example, namely:

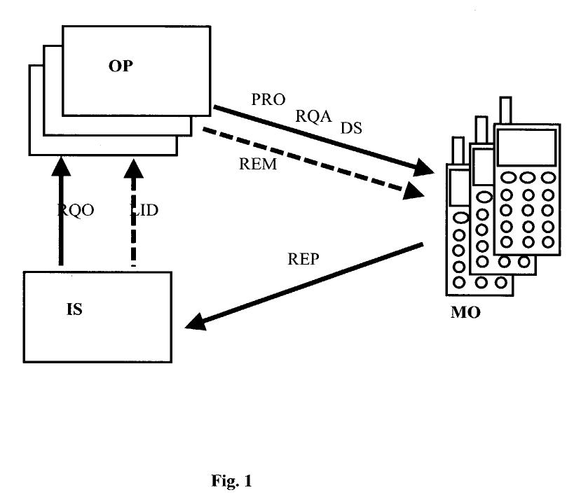

FIG. 1 represents the data exchanges between the different entities carried out during a sample survey by means of a mobile telephone.

A sample survey institute (IS) wishes to carry out a sample opinion poll of a population that complies with certain base criteria and that has a mobile telephone (MO). The institute sends a first request (RQO) to a mobile telephone network operator (OP) containing the criteria and the number of people to be polled.

The operator (OP) carries out the selection of the telephone numbers starting from the subscriber database, the contents of which are supplied by each subscriber at the end of the subscription period. The selection criteria can be very varied as for example, place of residence, age, sex, nationality, profession etc. A certain number of telephone numbers among those selected are then randomly chosen, their number relating to the size of the population sample to be polled. These subscribers are then solicited by a request (RQA) asking if they would like to participate in a sample opinion poll on current affairs, on how they intend to vote or on their opinion regarding a new product on the market. The request (RQA) is thus stored in the telephone of the person potentially to be polled, for example in the form of a short SMS message (other means of downloading the request will be available in the near future offering more flexibility than the SMS message).

This request proposes either to answer the following questions, or to answer within a given time limit (2 hours or 1 day for example) or no answer will be given. Furthermore, special offers can be proposed simultaneously to subscribers in order to encourage them to answer positively to the request. The method of this invention is based on a particular application consisting of adapted software (PRO) that is downloaded onto a SIM card and/or into the telephone memory.

This software includes the means to read out on the mobile telephone display screen the requests, the questions with the possible choice of answers and the messages related to the sample survey. Furthermore, it allows the validation of the answers to questions with the aid of the buttons on the keypad. Another important function of this software is to assure the management, encoding and automatic routing communications for the subscriber with the sample survey institute or with the operator and vice-versa.

According to a variant of the invention, this application (PRO) can be downloaded on all the telephones (MO) of the network of an operator (OP) when they are activated in such a way that the application is available during a sample survey advert.

The software (PRO) can also be included in the mobile telephone and form an integral part of other interactive applications including, in particular, games, lotteries, messaging etc. The downloading of the software (PRO) would be necessary only in the case of the old apparatus not being equipped with such an application or in the case of the updating of a previous version. Once the software (PRO) has been installed in the mobile telephone, it is thus ready to receive sample survey data (DS) which can be downloaded by different means, such as SMS, service channel USSP or other channels according to the usual standards.

For any given telephone, it is possible to memorize several sample survey requests (RQA) with their data (DS).

When the subscriber has carried out one of the memorized sample surveys entirely, the data (DS) related to this sample survey is deleted from the memory to free up space for new requests and future corresponding data.

The subscriber carries out the sample survey by selecting an answer that seems the most adequate among those proposed to the question asked. When the subscriber has answered all the sample survey questions, an adequate readout allows the validation of the set of answers and therefore the conclusion of the sample survey. The answers (REP) are then transmitted to the sample survey institute (IS) in the form of a message encoded by the software (PRO) containing the telephone number or preferably, an identification number for each subscriber known to the operator (OP).

The presence of an identification number is desirable on the one hand in order to avoid the same subscriber participating in the sample survey more than once and on the other hand, to avoid a message containing the telephone number of a user and his/her sample survey answers being intercepted.

According to another variant of the invention, it can then be used by the operator (OP) to reward the subscriber for his/her participation in the sample survey. The institute (IS) deletes the message answers (REP), after their storage, to only keep the identification number of the subscriber that will be registered in a list (LID).

The latter contains all the identification numbers of the subscribers that have provided answers recognized as valid. This list (LID) is then transmitted to the operator (OP) that relates the identification numbers with the telephone numbers and attributes to these subscribers the special offer that was promised when the sample survey request (RQA) was made, namely communication tariff reductions, free talk-time, free SMS messages etc.

According to another variant of the method of the invention, the operator (OP) can inform the subscriber by means of a short SMS message (REM) that first thanks the subscriber for participating in the sample survey and that informs the subscriber that the survey has been validated by the sample survey institute (IS) and that he/she can take advantage of the special offer. A late answer (outside the indicated time limit) to the participation request (RQA) is sent to the institute (IS) that treats late answers as an abstention for example. In this case, these subscribers are not introduced onto the list (LID) because they do not have to be rewarded by the operator (OP).

A negative answer to the request or exceeding the time limit without any answer leads to either the erasing of the sample survey data stored in the memory, or to the transmission of a message to the sample survey institute (IS) which records the negative answers. According to a variant, a new request (RQO) for the operator (OP) is immediately generated following such a message that selects a new subscriber number as a destination for a request (RQA) and data (DS). The answers to a sample opinion poll can prove insufficient, as the number of answers by category does not correspond to the statistical characteristics of a given population.

For example, the number of independent individuals over 60 living in the countryside is not high. In such a case the institute can ask the operator to carry out a new selection with new criteria and a higher number of random selections of subscriber identification numbers. In the previous example, the age range can be widened to independent individuals over 50 years of age.

The anonymity of the answers (REP) is guaranteed by the fact that the sample survey institute (IS) does not have access to the operator (OP) database containing the telephone numbers together with the subscriber's identity and characteristics. The answer messages (REP) received by the sample survey institute (IS) are generally in the form of a file with the identification number of each person polled. This file is created by the software (PRO) loaded in the subscriber's mobile telephone (MO). Therefore, the institute (IS) cannot establish a link between the numbers contained in the answer file (REP) that has been registered with the data stored in the mobile telephone network operator database (OP). Only the operator (OP) is able to interpret the list of numbers (LID) without the answers that are received from the institute (IS) in order to reward the subscribers that have participated in the sample survey.

The institute's (IS) sample survey can have a widespread scope by soliciting several mobile telephone network operators (OP) by the request (RQO) that in turn selects and randomly chooses the subscribers to be polled. In order to avoid instances of fraud that consist of other people or the sample survey institute (IS) answering in place of the individuals selected and randomly chosen by the operator (OP), an authentication of these individuals can be carried out by means of an electronic certificate, for example, of the type X 509. The latter is stored in the SIM card or in the mobile telephone memory.

The security of the data transmissions can be improved, especially by avoiding the transmission of subscribers' telephone numbers between the operators, the sample survey institute and the individuals polled. The operator generates, starting from the subscriber's telephone number for example, an identification number ID that is transmitted to the sample survey institute (IS). According to a variant, this number (ID) can be constant for a subscriber and for all the sample surveys or it can change for each sample survey request (RQA) transmitted to the subscriber.

At the moment of the diffusion of a sample survey request (RQA), the operator also transmits this ID number to the subscribers. The subscribers send back this number together with their answers (REP) to the sample survey questions to the institute (IS). The multiple answers of any given subscriber are deleted by comparing the ID numbers received with those previously provided by the operator.

Furthermore, this ID number can be automatically deleted from the telephone memory after sending the answers (REP), which also prevents the transmission of multiple sample survey answers by a subscriber. The institute (IS) then transmits the list (LID) of the subscribers having answered questions to the operator, this list only contains identification ID numbers that can only be interpreted by the operator to reward the subscribers polled.

According to a variant of the method according to the invention, the operator (OP) transmits to the sample survey institute (IS) the selected and randomly chosen numbers, the institute being responsible for the diffusion of the sample survey to the subscribers. The numbers of the individuals polled having answered are sent back to the operator.

According to another variant of the random selection of telephone numbers or of the identification and diffusion of the questions, the selection operations can be collated in the sample survey institute (IS). The latter has access to data regarding the individuals subscribed to one or more mobile telephone networks. One or more of the operators (OP) receive the lists (LID) of numbers of the sample survey participants to be rewarded.

The operators (OP) interested in increased traffic on the mobile telephone network can agglomerate their responsibilities with those of the sample survey institute (IS). Therefore, the operations such as the selection of numbers, the random choice, the transmission of the request and the sample survey data, the reception and recording of the answers are carried out by one and the same entity.

The selection of individuals to be polled can be carried out independently of the subscriber databases. In fact, the cellular configuration of the mobile telephone network allows a group of telephones in a determined area to be located when they are connected and validated by the network.

The operator then asks the network management system to collect the identification numbers of the active telephones in the cell. A sample survey request can thus be transmitted either to the group of telephones or to a certain number chosen randomly. For example, if one wishes to poll all the people in a shopping centre on their food preferences or the spectators in a stadium on their opinion regarding the event in progress. Other telephone interfaces can also be used for pinpointing an exact location, namely: the infrared interface, the Blue-Tooth or other connection means.

The localisation of the telephones also allows the operators to determine the most frequent actual location of the subscriber and his/her habitual movements. This data allows the definition of categories of people to be polled as for example individuals residing in a given district, or commuters travelling to a different town to work, or even those who travel regularly in another country connecting on associated networks.

Subscriber data based on inscriptions with the mobile telephone operators currently lacks precision, particularly in terms of the areas of interests, leisure, transport or subscribers' habits. With the aim of widening and enriching the sample surveys, the characteristics of the subscribers can be registered starting from questionnaires distributed by post, on the Internet or by signing up to loyalty services (letters to customers, store cards, access cards etc.). This data forms a centralized database accessible either to the sample survey institute (IS), or to operators (OP) in order to be used for the selection of telephone numbers or identification numbers. When the inscription is carried out, a subscriber completes his/her personal data by means of an identification number as well as a password. The ID number and password will be requested when said subscriber is invited to answer sample survey questions, this precaution prevents another person being able to take the call of the subscriber selected.

1. Opinion sample survey method carried out through a mobile telephone network, the sample survey being directed by a sample survey institute (IS) and the mobile telephone network being directed by at least one mobile telephone network operator (OP), characterized by the following steps:
selecting a group of telephone numbers provided by the mobile telephone network operator (OP) relating to subscribers complying with predefined criteria,
choosing randomly a fixed number of numbers among those selected previously,
transmitting a sample survey request (RQA) to previously selected numbers followed by the sample survey data,
receiving and memorizing by means of the mobile telephone (MO), which complies with the selected number, the sample survey data,
determining the appropriate time to present the sample survey to the mobile telephone user,
receiving the answers to the sample survey questions (REP),
transmitting, storing and recording the answers (REP) by the sample survey institute (IS).

2. Method according to claim 1, wherein the sample survey institute (IS) sends a request (RQO) to the operator (OP), said request comprising the selection criteria of subscribers' numbers.

3. Method according to claim 1, wherein the random choice of subscribers' numbers is carried out by the operator (OP), the number of said numbers relating to the size of the subscriber population to be query.

4. Method according to claim 1, wherein the mobile telephone includes an interactive software (PRO) adapted to sample surveys, said software forming an integral part of the complementary applications of said telephone.

5. Method according to claim 4, wherein the software (PRO) adapted to sample surveys, is downloaded onto a SIM card and/or into the subscriber's mobile telephone memory when the telephone is connected to the network.

6. Method according to claim 4, wherein the software (PRO) adapted to sample surveys, is downloaded onto a SIM card and/or into the subscriber's mobile telephone memory when the sample survey request (RQA) is sent to the subscriber.

7. Method according to claim 4, wherein the software (PRO) includes means to readout on the mobile telephone display screen the requests, the questions with the possible choice of answers and the messages related to the sample survey, as well as means to validate the answers with the buttons of the keypad.

8. Method according to claim 4, wherein the software assures the management, encoding and automatic subscriber routing communications to the sample survey institute or to the operator and vice-versa.

9. Method according to claim 4, wherein the software (PRO) includes means to memorize on a SIM card or in the mobile telephone memory a plurality of sample surveys containing the requests (RQA) and the sample survey data (DS), said sample surveys are deleted from the memory once the answers (REP) have been completed and sent to the sample survey institute (IS), leaving space available for new sample surveys.

10. Method according to claim 1, wherein the sample survey request (RQA) offers the subscriber the possibility, either to accept immediately or within a limited time period, or to refuse to participate in the sample survey.

11. Method according to claim 1, wherein the method comprises an authenticating step, carrying out by means of an electronic certificate of the type X 509 stored in the SIM card or in the mobile telephone memory.

12. Method according to claim 1, wherein the subscriber is informed by the request (RQA) that his/her participation in the sample survey is to be rewarded with special offers proposed by the operator (OP).

13. Method according to claim 1, wherein the answers to the sample survey (REP) are transmitted by the subscriber to the sample survey institute (IS) in the form of a file having the identification number of said subscriber.

14. Method according to claim 13, wherein the institute (IS) sends a list (LID) of the identification numbers of the subscribers having participated in the sample survey to the operator (OP), said operator attributes special offers to the subscribers whose numbers figure on said list (LID).

15. Method according to claim 1, wherein the operator (OP) transmits an answer acceptance message (REM) to each subscriber having validly answered the sample survey questions.

16. Method according to claim 1, wherein the operator (OP) transmits the selected and randomly chosen numbers to the sample survey institute (IS), said institute being responsible for the diffusion of the sample survey to subscribers and for the transmission back to the operator (OP) of the numbers of the individuals who have been polled and have answered.

17. Method according to claim 1, wherein the sample survey institute (IS) selects and chooses the subscribers' numbers and diffuses the sample survey to the subscribers, said institute (IS) having access to subscriber databases to telephone networks, the operators (OP) of said networks receive the lists (LID) of the numbers identifying the individuals who have been polled and have answered and reward the individuals polled whose numbers figure on these lists.

18. Method according to claim 1, wherein the operator (OP) carries out the tasks of the sample survey institute (IS) such as the selection of numbers, the random choice and the reception and the recording of the answers (REP), the sample survey being thus centralized in one and the same entity carried out by the operator (OP).
